(19) United States
(12) Patent Application Publication
(10) Pub. No.: US 2010/0260255 A1
(43) Pub. Date: Oct. 14, 2010

(54) METHOD AND SYSTEM FOR CLUSTERED FALLBACK FOR FRAME RATE UP-CONVERSION (FRUC) FOR DIGITAL TELEVISIONS

(76) Inventors: Krishna Sannidhi, King of Prussia, PA (US); Eric Klings, Freehold, NJ (US); Gerald Roletter, Philadelphia, PA (US)

Correspondence Address: MCANDREWS HELD & MALLOY, LTD, 500 WEST MADISON STREET, SUITE 3400, CHICAGO, IL, 60661, US

(21) Appl. No.: 12/560,561

(22) Filed: Sep. 16, 2009

Related U.S. Application Data
(60) Provisional application No. 61/168,744, filed on Apr. 13, 2009.

(51) Int. Cl. H04N 7/64; H04N 7/26

(52) U.S. Cl. 375/240.02; 375/E07.279; 375/E07.126

(57) ABSTRACT

A video decoder may be operable to divide a video frame into clusters during frame rate up-conversion (FRUC) process. The video decoder may be operable to determine an error associated with the displayed frame difference (DFD) for each of the clusters and switch between frame interpolation and frame repetition based on the error. A DFD histogram may be computed for each cluster and a condition for clustered fallback based on one or more of the DFD histograms may be determined. The clustered fallback may be entered if the condition for clustered fallback is met. The clustered fallback may be entered locally for one or more of the clusters of the video frame. The clustered fallback may be entered in such a way that if the number of consecutive video frames which meet the condition for clustered fallback is greater than a particular threshold value.

### CROSS-REFERENCE TO RELATED APPLICATIONS/INCORPORATION BY REFERENCE

This application makes reference to, claims priority to, and claims benefit from U.S. Provisional Application Ser. No. 61168744, which was filed on Apr. 13, 2009.

The above stated application is hereby incorporated herein by reference in its entirety.

### FIELD OF THE INVENTION

Certain embodiments of the invention relate to digital video processing. More specifically, certain embodiments of the invention relate to a method and system for clustered fallback for frame rate up-conversion (FRUC) for digital televisions.

### BACKGROUND OF THE INVENTION

A major revolution in video display technology includes flat screens based on either liquid crystal display (LCD) or plasma display panel (PDP) technology, which are rapidly replacing the cathode ray tube (CRT) technology that served as the primary display device for more than a half a century. A significant consequence of the new video display technologies is that pictures may now be displayed at higher frame rates with progressive scanning on a flat screen. The new video display technologies may also facilitate a faster transition from standard definition television (SDTV) to high-definition television (HDTV).

Digital television may support both HDTV and SDTV video formats while traditional analog television may support only SDTV video formats. Video formats are generally characterized based on a combination of their size, aspect ratio (width to height ratio) and interlacing. Some examples are 720p and 1080i formats for HDTV and NTSC, SECAM and PAL formats for SDTV. Video signals with different video formats may have different frame rates. For example, PAL or SECAM format shows 25 frames per second (fps) while NTSC format shows about 30 frames per second (fps). Most feature films are projected at a rate of 24 frames per second (fps). Display systems or devices such as HDTVs may be capable of displaying video at a rate of 60, 100, 120, 200 or even 240 Hz. Some form of frame rate conversion (FRC) may be employed to convert, for example, from low frame rates to high frames rates for various display systems or devices.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

A system and/or method for clustered fallback for frame rate up-conversion (FRUC) for digital televisions, substantially as shown in and/or described in connection with at least one of the figures, as set forth more completely in the claims.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram illustrating an exemplary video processing system that is operable to provide clustered fallback for frame rate up-conversion in digital televisions, in accordance with an embodiment of the invention.

FIG. 2 is a block diagram illustrating an exemplary video frame divided into small clusters, in accordance with an embodiment of the invention.

FIG. 3 is a block diagram illustrating an exemplary DFD histogram for each cluster, in accordance with an embodiment of the invention.

FIG. 4 is a flow chart illustrating exemplary steps for clustered fallback for frame rate up-conversion, in accordance with an embodiment of the invention.

### DETAILED DESCRIPTION OF THE INVENTION

Certain embodiments of the invention can be found in a method and system for clustered fallback for frame rate up-conversion (FRUC) for digital televisions. In various embodiments of the invention, a video decoder may be operable to divide a video frame into a plurality of clusters during frame rate up-conversion (FRUC) process, in which each cluster may comprise one or more pixels. The video decoder may be operable to determine the error associated with the displayed frame difference (DFD) for each of the plurality of clusters and switch between frame interpolation and frame repetition based on the determined error. In this regard, the video decoder may be operable to compute a displayed frame difference (DFD) histogram for each of the plurality of clusters. The DFD histogram for each of the plurality of clusters may comprise a plurality of DFD error categories, a count of pixels for each of the DFD error categories and a category threshold for each of the DFD error categories. The video decoder may be operable to determine a condition for the clustered fallback based on one or more of the DFD histograms. The clustered fallback may be entered in instances when the condition for clustered fallback is met, and kept alive, and then may be exited when the condition for clustered fallback is no longer met. In this regard, the video decoder may be operable to enter the clustered fallback in instances when the count of pixels in a DFD error category in the DFD histogram for a cluster is greater than the category threshold of that DFD error category and exit the clustered fallback in instances when the count of pixels in that DFD error category is less than or equal to the category threshold.

The video decoder may be operable to enter the clustered fallback in instances when counts of pixels in a plurality of DFD error categories in the DFD histograms for one or more of the plurality of clusters are greater than the corresponding category thresholds of those DFD error categories and exit the clustered fallback in instances when the counts of pixels in those DFD error categories are less than or equal to the corresponding category thresholds. The video decoder may be operable to enter the clustered fallback in instances when the combined count of pixels in a plurality of DFD error categories in the DFD histograms for one or more of the plurality of clusters is greater than the combined category threshold of those DFD error categories and exit the clustered fallback in instances when the combined count of pixels in those DFD error categories is less than or equal to the combined category threshold. The video decoder may be operable to lower the DFD error category thresholds after the clustered fallback is entered and reset the category thresholds to initial settings upon exiting the clustered fallback.

The clustered fallback may be entered locally for one or more of the plurality of clusters of the video frame in instances when the condition for the clustered fallback is met for that one or more of the plurality of clusters and kept alive. The clustered fallback may be exited for that one or more of the plurality of clusters of the video frame when the condition for clustered fallback for that one or more of the plurality of clusters is no longer met. The video decoder may also be operable to enter the clustered fallback when the first count of consecutive video frames which meet the condition for the clustered fallback is greater than a consecutive threshold. For such conditions, the clustered fallback may be entered and kept alive. The clustered fallback may be exited when the second count of consecutive video frames which no longer meet the condition for the clustered fallback is greater than the consecutive threshold. The two counts which may be used to determine the number of consecutive video frames may be reset during scene change and/or in instances when the DFD histogram may not be used to determine the clustered fallback.

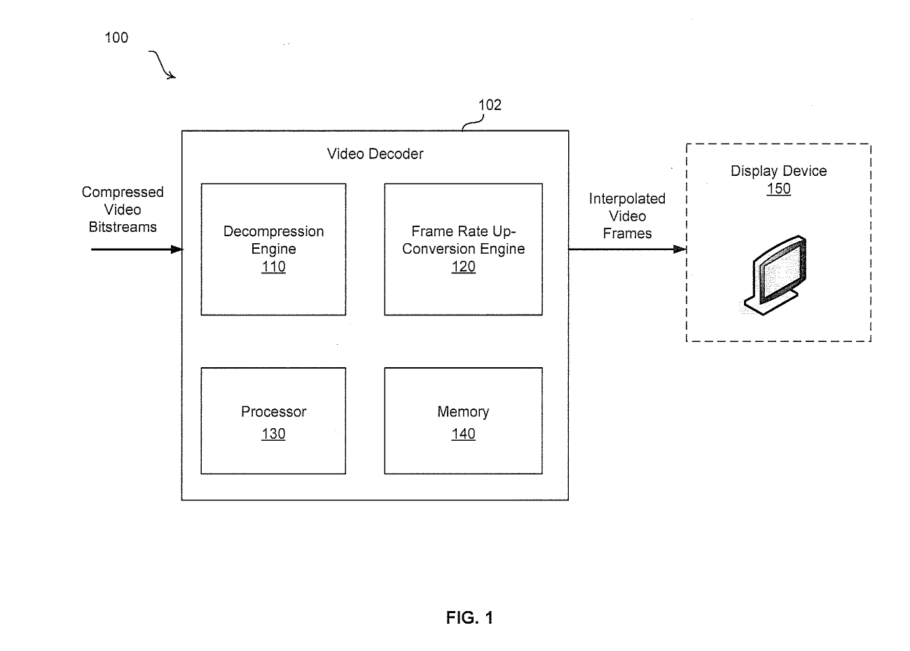

FIG. 1 is a block diagram illustrating an exemplary video processing system that is operable to provide clustered fallback for frame rate up-conversion in digital televisions, in accordance with an embodiment of the invention. Referring to FIG. 1, there is shown a video processing system 100. The video processing system 100 may comprise a video decoder 102 and a display device 150. The video decoder 102 may comprise a decompression engine 110, a frame rate up-conversion engine 120, a processor 130 and a memory 140.

The video decoder 102 may comprise suitable logic, circuitry, interfaces and/or code that may be operable to receive compressed video bitstreams, decompress received video bitstreams, up-convert frame rate and generate interpolated video frames with a high frame rate for display.

The decompression engine 110 may comprise suitable logic, circuitry, interfaces and/or code that may be operable to decompress compressed video bitstreams received to generate decoded video frames. The decompression engine 110 may be operable to perform various video decoding/decompression operations such as, for example, entropy decoding, inverse quantization, inverse transform, and motion compensated prediction. The decompression engine 110 may be operable to provide decoded video frames to the frame rate up-conversion engine 120 for further video decoding processing.

The frame rate up-conversion engine 120 may comprise suitable logic, circuitry, interfaces and/or code that may be operable to up-convert frame rate to provide high picture quality results for a high quality video source comprising, for example, a digital betacam, camera video, and/or telecine transferred films. In this regard, the frame rate up-conversion engine 120 may be operable to extract coding information such as, for example, block motion vectors, block coding modes, quantization levels, and quantized residual data, from the received compressed video bitstreams. The extracted coding information may be utilized to perform frame rate up-conversion on the received compressed video bitstreams. Various frame rate conversion algorithms such as frame repetition and linear interpolation by temporal filtering may be utilized by the frame rate up-conversion engine 120 to construct interpolated video frames with a high frame rate for display on the display device 150. Frame interpolation may be used to reduce judder to smooth the picture. Frame repetition may be used, for example, in instances when interpolation may produce an interpolated frame with many visual artifacts.

The fallback is a mechanism to stop generating interpolated frames, for example, 120 Hz interpolated frames and simply repeat captured frames when the frame rate up-conversion engine 120 may be producing an interpolated frame with many visual artifacts. The displayed frame difference (DFD) is a metric which may be used to indicate residual image error created during the motion-compensated frame interpolation process. The DFD may be the difference between the current video frame and a predicted frame, where the predicted frame may be obtained using motion compensation on the previously coded frame. The interpolated frame may be generated by predicting the pixels at each location in the frame based on candidate motion vectors. A motion vector may be used to represent or predict an area such as block, region or cluster in a video frame based on the position of this area in another frame, the latter of which may be referred to as a reference frame. The cluster may be a group of pixels, for example, a group of 16×16 pixels in MPEG. In instances when the predicted motion vectors are correct and there are no occlusions then for any location in the interpolated frame for the particular motion vector that was selected, the pixel would match exactly. Any slight error in the motion vector may cause potential pixel differences. If the difference is large, it may imply that the motion vector assigned for that location may be incorrect. In this regard, a count of such large DFD errors in the video frame or in one or more of the clusters may give enough information about how well the interpolation is being done and whether the fallback mode should be entered. A global fallback may be used to identify the entire video frame for DFD errors and enter the fallback on such video frame. In an embodiment of the invention, a clustered fallback may be used to identify one or more of the clusters with high concentration of DFD errors and enter the fallback on such video frame. The frame rate up-conversion engine 120 may be operable to divide the video frame into a plurality of clusters. The frame rate up-conversion engine 120 may be operable to determine the error associated with the DFD for each of the clusters and switch between frame interpolation and frame repetition based on the determined DFD errors in one or more of the clusters.

The processor 130 may comprise suitable logic, circuitry, interfaces and/or code that may be operable to process compressed video bitstreams. The processor 130 may be operable to communicate the received compressed video bitstreams with the decompression engine 110 for corresponding decoded video frames of the received compressed video bitstreams. The decoded video frames may be served as reference video frames in the frame rate up-conversion for final interpolated video frames. The processor 130 may be operable to communicate the final interpolated video frames with the display device 150 for display.

The memory 140 may comprise suitable logic, circuitry, interfaces and/or code that may enable storing of information such as executable instructions and data that may be utilized by the processor 130, the frame rate up-conversion engine 120, and/or the decompression engine 110. The executable instructions may comprise various video process algorithms such as video decompression and frame rate up-conversion that may be utilized by the decompression engine 110 and the frame rate up-conversion engine 120, respectively. The data may comprise the received compressed video bitstreams, coding information extracted from the received compressed video bitstreams, decoded video frames, and/or interpolated video frames. The extracted coding information may comprise block motion vectors, block coding modes, quantization levels, and quantized residual data, for example, to be utilized by the frame rate up-conversion engine 120. The memory 140 may comprise RAM, ROM, low latency nonvolatile memory such as flash memory and/or other suitable electronic data storage.

The display device 150 may comprise suitable logic, circuitry, interfaces and/or code that may be operable to display video frames to users. The display device 150 may be operable to use various interfaces such as a high definition multimedia interface (HDMI), Ethernet, and/or a Display port.

In operation, the processor 130 may be operable to receive compressed video bitstreams. The processor 130 may be operable to communicate the received compressed video bitstreams with the decompression engine 110 for corresponding decoded video frames. The decoded video frames may be interpolated by the frame rate up-conversion engine 120 resulting interpolated video frames. In this regard, the frame rate up-conversion engine 120 may be operable to utilize coding information extracted from the received compressed video bitstreams in the decompression engine 110. The resulted interpolated video frames constructed by the frame rate up-conversion engine 120 may be communicated with the processor 130 for display on the display device 150. The frame rate up-conversion engine 120 may be operable to divide the video frame into a plurality of clusters. In instances when the frame rate up-conversion engine 120 determines that the frame interpolation is likely to fail based on the DFD errors in one or more of the clusters, the frame rate up-conversion engine 120 may be operable to enter the fallback mode to switch off frame interpolation across scene changes and continue repeating previous frames.

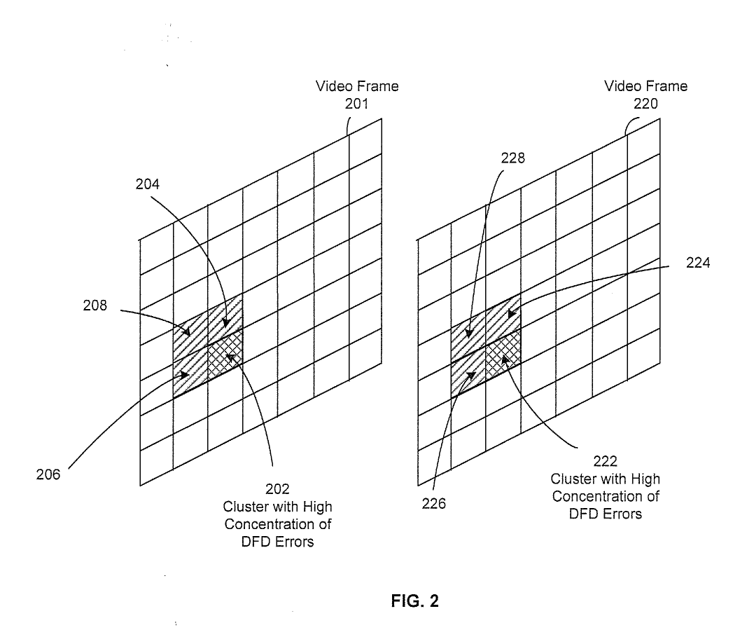

FIG. 2 is a block diagram illustrating an exemplary video frame divided into small clusters, in accordance with an embodiment of the invention. Referring to FIG. 2, there is shown a plurality of consecutive video frames, for example, video frame 201 and video frame 220. The video frame 201 may be divided into small clusters or blocks, for example, the clusters 202, 204, 206, 208. The video frame 220 may be divided into small clusters or blocks, for example, the clusters 222, 224, 226, 228. The cluster, for example, the cluster 202 may be a group of pixels, for example, a group of 16×16 pixels in MPEG. In the exemplary embodiment of the invention illustrated in FIG. 2, the video frame 201 or the video frame 220 is divided into 49 clusters. Notwithstanding, the invention is not so limited and the amount of divided clusters may be different.

In an embodiment of the invention, a clustered fallback may be used to identify a cluster, for example, the cluster 202 with high concentration of DFD errors and enter the fallback on such video frame 201. If a cluster, for example, the cluster 202 with small objects, such as a football or ropes of a swing in the video frame 201 has very high concentration of DFD errors, it may make the viewing experience of video frame 201 unpleasing, even in instances when the rest of the video frame 201 may look good. Using a global fallback to examine the entire video frame 201 for DFD errors may not be enough to provide a fallback for such objects. However, using a clustered fallback to examine the cluster 202 for DFD errors may be optimal or sufficient to provide fallback for such objects.

Since entering and exiting the fallback may make the video image jerky, a clustered fallback may be entered in instances where sufficient consecutive clusters, for example, the clusters 202 and 222 are found to have a high concentration of DFD errors, and the clustered fallback may be kept alive until sufficient consecutive clusters, for example, the clusters 202 and 222 are found without high concentration of DFD errors. In this regard, two counts may be maintained and compared to a particular threshold value, namely, for example, a consecutive threshold to decide when to enter and exit clustered fallback. For example, in instances where the consecutive threshold may be set to 10, the clustered fallback may be triggered only after 10 consecutive video frames, for example, the video frames 201 and 220 with high concentration of DFD errors for a cluster, for example, the clusters 202 and 222 are found and may remain active until 10 consecutive video frames, for example, the video frames 201 and 220 without high concentration of DFD errors for that cluster, for example, the clusters 202 and 222 are found. These two counts may be reset during scene change (the previous and next frames are quite different) or in instances when the DFD errors may not be used as a measure to determine with some level of confidence, a quality of the resulting interpolation.

In an embodiment of the invention, more than one cluster or a combination of clusters, for example, clusters 202, 204, 206, 208 may be used to determine when to enter or exit the clustered fallback. In another embodiment of the invention, instead of falling back for the entire video frame 201, a clustered fallback may be entered specifically for the cluster 202 (or for some clusters such as clusters 204, 206, 208) with high concentration of DFD errors so that the pixels in the cluster 202 (or in clusters 204, 206, 208) may be smoothened or blended locally to reduce the effect of bad interpolation. In this regard, the fallback may not be entered for the rest of the video frame 201.

In operation, the frame rate up-conversion engine 120 may be operable to divide the video frame 201 into small clusters, for example, the clusters 202, 204, 206, 208. The frame rate up-conversion engine 120 may be operable to determine the concentration of the DFD errors for each cluster, for example, the cluster 202. If the determined conditions of high concentration of DFD errors for the cluster 202 or for a combination of clusters, for example, the clusters 202, 204, 206, 208 are met, the frame rate up-conversion engine 120 may be operable to enter the fallback on the video frame 201 and may keep the fallback alive until the conditions of high concentration of DFD errors are no longer met. The frame rate up-conversion engine 120 may also be operable to enter the fallback for a cluster, for example, cluster 202 with high concentration of DFD errors for local smoothing or blending and may not be operable to enter the fallback for the rest of the video frame 201.

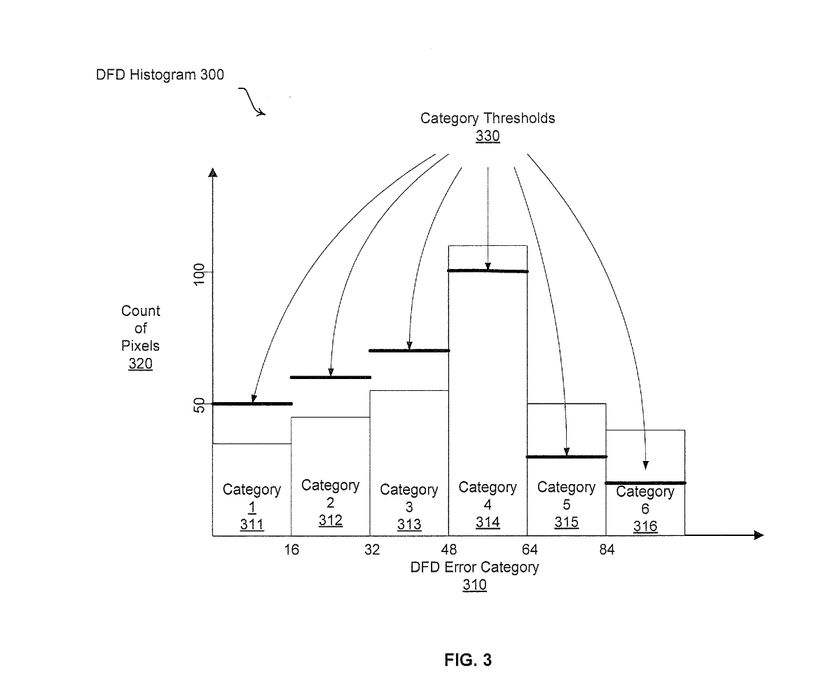

FIG. 3 is a block diagram illustrating an exemplary DFD histogram for each cluster, in accordance with an embodiment of the invention. Referring to FIG. 3, there is shown a DFD histogram 300 for each cluster. The DFD histogram 300 comprises DFD error categories 310, counts of pixels 320 and category thresholds 330.

The horizontal axis (x-axis) of the DFD histogram 300 may represent the DFD error categories 310, for example, category 1 311, category 2 312, category 3 313, category 4 314, category 5 315 and category 6 316. The category 1 311 may represent the lowest DFD errors range, for example, between 1 and 16 and the category 6 316 may represent the highest DFD errors range, for example greater than 84. The number of DFD error categories 310 may be increased or decreased based on the performance of the frame rate up-conversion algorithm. The vertical axis (y-axis) of the DFD histogram 300 may represent counts of pixels 320 in each of the DFD error categories 310. In this regard, for example, in instances where the DFD error is found to be 35, then the count of pixels 320 of the category 3 313 (the third bin) may be increased by one. A category threshold 330 may be set for each DFD error category 310 and the clustered fallback may be entered in instances where the count of pixels 320 of a DFD error category 310, for example, the category 4 314 is greater than the corresponding category threshold 330. The clustered fallback may also be entered by comparing more than one DFD error category 310 against their category thresholds 330. The clustered fallback may also be entered by comparing a combination of DFD error categories 310. In this regard, for example, the clustered fallback may be triggered in instances where the count of DFD errors from the category 4 314 are greater than 100 and the combined count of DFD errors from the category 5 315 and the category 6 316 are greater than 50. The category threshold 330 for each DFD error category 310 may be set or determined by experimenting with test video clips and based on how well the frame rate up-conversion algorithm may be performing.

In an embodiment of the invention, once the clustered fallback mode has been entered, the category thresholds 330 used to determine the fallback may be lowered so that the fallback may happen more easily. Upon exiting the clustered fallback mode, the category threshold 330 may be reset back to their initial settings.

In an embodiment of the invention, the clustered fallback may be made more sensitive to DFD errors in the middle of the video frame 201, when compared to the DFD errors at borders, making the video frame 201 more visually pleasing to the viewer. In addition, since the DFD errors may usually be higher at borders of the video frame 201 when compared to the central part of the video frame 201, the category thresholds 330 for clusters at borders may be set higher when compared to the center part of the video frame 201. In this instance, the fallback may be more difficult to enter because of border artifacts and easier to enter if interpolation is not done correctly in the middle of the video frame 201. Another way to achieve the same effect is to scale down the DFD errors at borders keeping the category thresholds 330 the same.

In another embodiment of the invention, the clustered fallback may also be used in addition to the global fallback thus combining advantages of both the algorithms. One way to do this is to enter fallback when any of the conditions for clustered fallback or global fallback are met. Another way to do this is to let the global fallback determine when to fallback but decrease or increase its category thresholds 330 based on how many clusters have high DFD errors. This may make the global fallback take the advantage of the clustered fallback in finding high concentration of DFD errors.

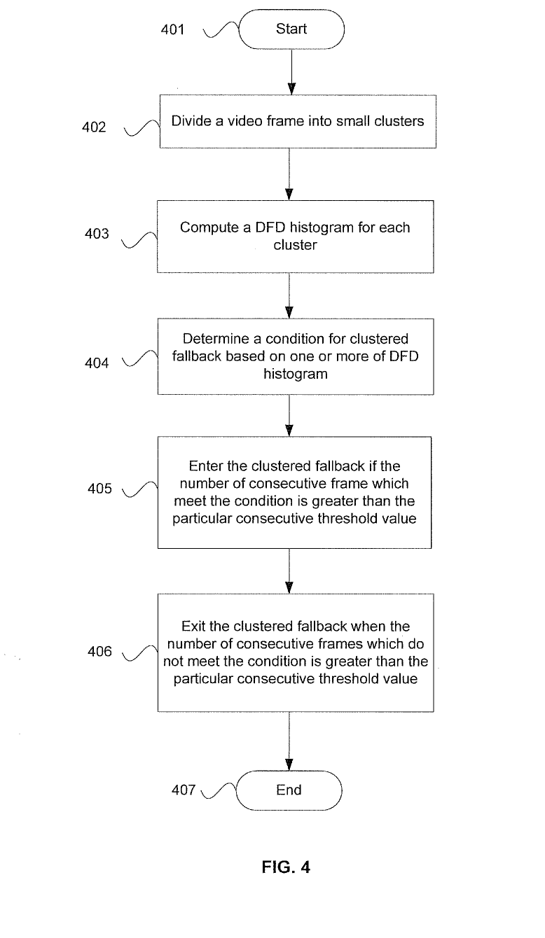

FIG. 4 is a flow diagram illustrating exemplary steps for clustered fallback for frame rate up-conversion, in accordance with an embodiment of the invention. Referring to FIG. 4, in step 402 after start step 401, the frame rate up-conversion engine 120 may be operable to divide a video frame into small clusters. In step 403, the frame rate up-conversion engine 120 may be operable to compute a DFD histogram for each cluster. The DFD histogram comprises DFD error categories, a count of pixels for each DFD error category and category thresholds for corresponding DFD error categories. In step 404, the frame rate up-conversion engine 120 may be operable to determine a condition for clustered fallback based on one or more of DFD histograms. In step 405, the clustered fallback may be entered if the number of consecutive frames which meet the condition is greater than the particular consecutive threshold value. In step 406, the clustered fallback may be exited when the number of consecutive frames which do not meet the condition is greater than the particular consecutive threshold value. The exemplary steps may proceed to the end step 407.

In various embodiments of the invention, a video decoder 102 may be operable to divide a video frame 201 into a plurality of clusters 202, 204, 206, 208 during frame rate up-conversion (FRUC) process, in which each cluster may comprise one or more pixels. The video decoder 102 may be operable to determine the error associated with the displayed frame difference (DFD) for each of the plurality of clusters 202, 204, 206, 208 and switch between frame interpolation and frame repetition based on the determined error. In this regard, the video decoder 102 may be operable to compute a displayed frame difference (DFD) histogram 300 for each of the plurality of clusters 202, 204, 206, 208. The DFD histogram 300 for each of the plurality of clusters 202, 204, 206, 208 may comprise a plurality of DFD error categories 310, a count of pixels 320 for each of the DFD error categories 310 and a category threshold 330 for each of the DFD error categories 310. The video decoder 102 may be operable to determine a condition for the clustered fallback based on one or more of the DFD histograms 300. The clustered fallback may be entered in instances when the condition for clustered fallback is met, and kept alive, and then may be exited when the condition for clustered fallback is no longer met. In this regard, the video decoder 102 may be operable to enter the clustered fallback in instances when the count of pixels 320 in a DFD error category 314 in the DFD histogram 300 for a cluster 202 is greater than the category threshold 330 of that DFD error category 314 and exit the clustered fallback in instances when the count of pixels 320 in that DFD error category 314 is less than or equal to the category threshold 330.

The video decoder 102 may be operable to enter the clustered fallback in instances when counts of pixels 320 in a plurality of DFD error categories 310 in the DFD histograms 300 for one or more of the plurality of clusters 202, 204, 206, 208 are greater than the corresponding category thresholds 330 of those DFD error categories 310 and exit the clustered fallback in instances when the counts of pixels 320 in those DFD error categories 310 are less than or equal to the corresponding category thresholds 330. The video decoder 102 may be operable to enter the clustered fallback in instances when the combined count of pixels in a plurality of DFD error categories 310 in the DFD histograms 300 for one or more of the plurality of clusters 202, 204, 206, 208 is greater than the combined category threshold of those DFD error categories 310 and exit the clustered fallback in instances when the combined count of pixels in those DFD error categories 310 is less than or equal to the combined category threshold. The video decoder 102 may be operable to lower the DFD error category thresholds 330 after the clustered fallback is entered and reset the category thresholds 330 to initial settings upon exiting the clustered fallback.

The clustered fallback may be entered locally for one or more of the plurality of clusters 202, 204, 206, 208 of the video frame 201 in instances when the condition for the clustered fallback is met for that one or more of the plurality of clusters 202, 204, 206, 208 and kept alive. The clustered fallback may be exited for that one or more of the plurality of clusters 202, 204, 206, 208 of the video frame 201 when the condition for clustered fallback for that one or more of the plurality of clusters 202, 204, 206, 208 is no longer met. The video decoder 102 may also be operable to enter the clustered fallback when the first count of consecutive video frames 201, 220 which meet the condition for the clustered fallback is greater than a consecutive threshold. For such conditions, the clustered fallback may be entered and kept alive. The clustered fallback may be exited when the second count of consecutive video frames 201, 220 which no longer meet the condition for the clustered fallback is greater than the consecutive threshold. The two counts which may be used to determine the number of consecutive video frames 201, 220 may be reset during scene change and/or in instances when the DFD histogram 300 may not be used to determine the clustered fallback.

Another embodiment of the invention may provide a machine and/or computer readable storage and/or medium, having stored thereon, a machine code and/or a computer program having at least one code section executable by a machine and/or a computer, thereby causing the machine and/or computer to perform the steps as described herein for clustered fallback for frame rate up-conversion (FRUC) for digital televisions.

Accordingly, the present invention may be realized in hardware, software, or a combination of hardware and software. The present invention may be realized in a centralized fashion in at least one computer system or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for processing video, the method comprising:
performing by one or more processors and/or circuits in a video decoder:
dividing a video frame into a plurality of clusters during frame rate up-conversion (FRUC), wherein each of said plurality of divided clusters comprises one or more pixels;
determining an error associated with a displayed frame difference (DFD) for each of said plurality of clusters; and
switching between frame interpolation and frame repetition based on said determined error.

2. The method according to claim 1, comprising:
computing a displayed frame difference (DFD) histogram for each of said plurality of clusters; and
determining a condition for a clustered fallback based on one or more of said computed DFD histograms for said plurality of clusters.

3. The method according to claim 2, comprising:
entering said clustered fallback when a count of pixels in a DFD error category in said DFD histogram for one of said plurality of clusters is greater than a category threshold of said DFD error category; and
exiting said clustered fallback when said count of pixels in said DFD error category in said DFD histogram for said one of said plurality of clusters is less than or equal to said category threshold of said DFD error category.

4. The method according to claim 3, comprising:
lowering said category threshold after entering said clustered fallback; and
resetting said category threshold to initial setting upon exiting said clustered fall back.

5. The method according to claim 2, comprising:
entering said clustered fallback when counts of pixels in a plurality of DFD error categories in said DFD histograms for one or more of said plurality of clusters are greater than corresponding category thresholds of said plurality of DFD error categories; and
exiting said clustered fallback when said counts of pixels in said plurality of DFD error categories in said DFD histograms for said one or more of said plurality of clusters are less than or equal to said corresponding category thresholds of said plurality of DFD error categories.

6. The method according to claim 5, comprising:
lowering said corresponding category thresholds after entering said clustered fallback; and
resetting said corresponding category thresholds to initial settings upon exiting said clustered fallback.

7. The method according to claim 2, comprising:
entering said clustered fallback when a combined count of pixels in a plurality of DFD error categories in said DFD histograms for one or more of said plurality of clusters is greater than a combined category threshold of said plurality of DFD error categories; and
exiting said clustered fallback when said combined count of pixels in said plurality of DFD error categories in said DFD histograms for said one or more of said plurality of clusters is less than or equal to said combined category threshold of said plurality of DFD error categories.

8. The method according to claim 2, comprising:
entering said clustered fallback for one or more of said plurality of clusters of said video frame when said condition for said clustered fallback is met; and
exiting said clustered fallback for said one or more of said plurality of clusters of said video frame when said condition for said clustered fallback is not met.

9. The method according to claim 2, comprising:
entering said clustered fallback when a first count of consecutive video frames which meet said condition for said clustered fallback is greater than a consecutive threshold; and
exiting said clustered fallback when a second count of consecutive video frames which do not meet said condition for said clustered fallback is greater than said consecutive threshold.

10. The method according to claim 9, comprising resetting said first count and said second count during scene change and/or when said DFD histogram may not be used to determine said clustered fallback.

11. A system for processing video, the system comprising:
one or more processors and/or circuits for use in a video decoder, wherein said one or more processors and/or circuits are operable to:
divide a video frame into a plurality of clusters during frame rate up-conversion (FRUC), wherein each of said plurality of divided clusters comprises one or more pixels;
determine an error associated with a displayed frame difference (DFD) for each of said plurality of clusters; and
switch between frame interpolation and frame repetition based on said determined error.

12. The system according to claim 11, wherein said one or more processors and/or circuits are operable to:
compute a displayed frame difference (DFD) histogram for each of said plurality of clusters; and
determine a condition for a clustered fallback based on one or more of said computed DFD histograms for said plurality of clusters.

13. The system according to claim 12, wherein said one or more processors and/or circuits are operable to:
enter said clustered fallback when a count of pixels in a DFD error category in said DFD histogram for one of said plurality of clusters is greater than a category threshold of said DFD error category; and
exit said clustered fallback when said count of pixels in said DFD error category in said DFD histogram for said one of said plurality of clusters is less than or equal to said category threshold of said DFD error category.

14. The system according to claim 13, wherein said one or more processors and/or circuits are operable to:
lower said category threshold after entering said clustered fallback; and
reset said category threshold to initial setting upon exiting said clustered fall back.

15. The system according to claim 12, wherein said one or more processors and/or circuits are operable to:
enter said clustered fallback when counts of pixels in a plurality of DFD error categories in said DFD histograms for one or more of said plurality of clusters are greater than corresponding category thresholds of said plurality of DFD error categories; and
exit said clustered fallback when said counts of pixels in said plurality of DFD error categories in said DFD histograms for said one or more of said plurality of clusters are less than or equal to said corresponding category thresholds of said plurality of DFD error categories.

16. The system according to claim 15, wherein said one or more processors and/or circuits are operable to:
lower said corresponding category thresholds after entering said clustered fallback; and
reset said corresponding category thresholds to initial settings upon exiting said clustered fallback.

17. The system according to claim 12, wherein said one or more processors and/or circuits are operable to:
enter said clustered fallback when a combined count of pixels in a plurality of DFD error categories in said DFD histograms for one or more of said plurality of clusters is greater than a combined category threshold of said plurality of DFD error categories; and
exit said clustered fallback when said combined count of pixels in said plurality of DFD error categories in said DFD histograms for said one or more of said plurality of clusters is less than or equal to said combined category threshold of said plurality of DFD error categories.

18. The system according to claim 12, wherein said one or more processors and/or circuits are operable to:
enter said clustered fallback for one or more of said plurality of clusters of said video frame when said condition for said clustered fallback is met; and
exit said clustered fallback for said one or more of said plurality of clusters of said video frame when said condition for said clustered fallback is not met.

19. The system according to claim 12, wherein said one or more processors and/or circuits are operable to:
entering said clustered fallback when a first count of consecutive video frames which meet said condition for said clustered fallback is greater than a consecutive threshold; and
exiting said clustered fallback when a second count of consecutive video frames which do not meet said condition for said clustered fallback is greater than said consecutive threshold.

20. The system according to claim 19, wherein said one or more processors and/or circuits are operable to reset said first count and said second count during scene change and/or when said DFD histogram may not be used to determine said clustered fallback.
